(19) United States
(12) Patent Application Publication
(10) Pub. No.: US 2013/0128191 A1
(43) Pub. Date: May 23, 2013

(54) DISPLAY PANEL

(71) Applicants: Jehao Hsu, Shenzhen (CN); Xiaohui Yao, Shenzhen (CN); Jing-feng Xue, Shenzhen (CN); Chengcai Dong, Shenzhen (CN)

(72) Inventors: Jehao Hsu, Shenzhen (CN); Xiaohui Yao, Shenzhen (CN); Jing-feng Xue, Shenzhen (CN); Chengcai Dong, Shenzhen (CN)

(73) Assignee: Shenzhen China Star Optoelectronics Technology Co., Ltd., Shenzhen (CN)

(21) Appl. No.: 13/380,228

(22) PCT Filed: Nov. 25, 2011
(86) PCT No.: PCT/CN11/82923

§ 371 Date: Dec. 22, 2011

(30) Foreign Application Priority Data
Nov. 22, 2011 (CN) 201110373219.2

(51) Int. Cl. G02F 1/1335

(52) U.S. Cl. 349/96

(57) ABSTRACT

The present invention provides a display pane comprising a liquid crystal cell and two polarizers disposed at both sides of the liquid crystal cell, wherein one of the polarizers at one side of the liquid crystal cell includes a compensation film, and a first optical path difference R₀ of the compensation film is 0.15 to 0.35 times an optical path difference R of the liquid crystal cell. The liquid crystal display pane of the present invention can have a low cost and a wide viewing angle, so as to solve the problems that the contrast of the conventional display panel is reduced, and the dual compensation films have a higher cost.

### FIELD OF THE INVENTION

The present invention relates to a field of a liquid crystal display technology, and more particularly to a display panel with a low cost and a wide viewing angle.

### BACKGROUND OF THE INVENTION

At present, a liquid crystal display (LCD) panel can apply an electric field to rotate liquid crystal (LC) molecules for alter a polarization state of an incident light, so as to control light rays of a backlight source to pass the LCD panel or not. In this case, the forming of the polarized light is determined by polarizers which are disposed at both sides of the LC cell. The electric field can control the orientation of the liquid crystal molecules in the LC cell for altering the polarization state of the light passing through the LC cell. However, when a user views the display panel from different directions, the light transmittance of the panel from different directions is different due to different orientations of the liquid crystal molecules. That is, the LC molecules have a larger optical path difference (OPD) at different viewing angles, thereby deteriorating the normal display of the display panel.

With regard to the problem that the LC molecules in the display panel have the larger optical path difference at different viewing angles resulting in a low contrast of the display panel at a wide viewing angle, in the conventional technology, compensation films are disposed on the polarizers which are disposed at outer sides of the LC cell for compensating the optical path between the LC molecules at the large viewing angle by adjusting the refractive index of the compensation films. In general, the compensation films on the LC cell are designed as dual compensation films. That is, two compensation films are disposed on the polarizers at both sides of the LC cell, respectively. However, the material of the compensation films is more expensive, and thus the cost of the dual compensation films is higher.

As a result, it is necessary to provide a display panel to solve the problems existing in the conventional technologies, as described above.

### SUMMARY OF THE INVENTION

A primary object of the present invention is to provide a display panel with a low cost and a wide viewing angle, so as to solve the problems that the contrast of the conventional display panel is reduced, and the dual compensation films have a higher cost.

For solving the above-mentioned problems, the technical solutions are provided by the present invention as below:

The present invention relates to a display panel, comprising: a liquid crystal cell; and two polarizers disposed at both sides of the liquid crystal cell, respectively, wherein one of the polarizers at one side of the liquid crystal cell includes a compensation film, and a first optical path difference R₀ of the compensation film is 0.15 to 0.35 times an optical path difference R of the liquid crystal cell, and the first optical path difference R₀ and the optical path difference R of the liquid crystal cell are expressed as follows: R₀=|nₓ−n_{y}|×d, R=Δn×d′, wherein nₓ indicates the refractive index of the compensation film in a first direction, and n_{y} indicates the refractive index of the compensation film in a second direction, and the first direction and the second direction are vertical to each other and parallel to a light-incident surface of the compensation film, and d indicates a thickness of the compensation film, and Δn indicates a refractive index difference of liquid crystal molecules of the liquid crystal cell, and d′ indicates a thickness of the liquid crystal cell; wherein a second optical path difference Rₜₕ of the compensation film is 0.6 to 1.2 times the optical path difference R of the liquid crystal cell, and the second optical path difference Rₜₕ of the compensation film is expressed as follows: Rₜₕ=|(nₓ+n_{y})/2−n_{z}|*d, wherein n_{z} indicates the refractive index of the compensation film in a third direction, and the third direction is vertical to the first direction and the second direction, and a value of Δn is 0.07 to 0.11, and a value of d′ is 3 μm to 4 μm, and the compensation film is disposed on one of the polarizers at a light-incident side or a light-emitting side of the liquid crystal cell, and the compensation film is disposed between a polarizing film of the polarizers and the liquid crystal cell.

The present invention relates to a display panel, comprising: a liquid crystal cell; and two polarizers disposed at both sides of the liquid crystal cell, respectively, wherein one of the polarizers at one side of the liquid crystal cell includes a compensation film, and a first optical path difference R₀ of the compensation film is 0.15 to 0.35 times an optical path difference R of the liquid crystal cell, and the first optical path difference R₀ and the optical path difference R of the liquid crystal cell are expressed as follows: R₀=|nₓ−n_{y}|×d, R=Δn×d′, wherein nₓ indicates the refractive index of the compensation film in a first direction, and n_{y} indicates the refractive index of the compensation film in a second direction, and the first direction and the second direction are vertical to each other and parallel to a light-incident surface of the compensation film, and d indicates a thickness of the compensation film, and Δn indicates a refractive index difference of liquid crystal molecules of the liquid crystal cell, and d′ indicates a thickness of the liquid crystal cell.

In the display panel of the present invention, a second optical path difference Rₜₕ of the compensation film is 0.6 to 1.2 times the optical path difference R of the liquid crystal cell, and the second optical path difference Rₜₕ of the compensation film is expressed as follows: Rₜₕ=|(nₓ+n_{y})/2−n_{z}|*d, wherein n_{z} indicates the refractive index of the compensation film in a third direction, and the third direction is vertical to the first direction and the second direction.

In the display panel of the present invention, a value of Δn is 0.07 to 0.11.

In the display panel of the present invention, a value of d′ is 3 μm to 4 μm.

In the display panel of the present invention, a value of Δn is 0.07 to 0.11, and a value of d′ is 3 μm to 4 μm.

In the display panel of the present invention, the compensation film is disposed on one of the polarizers at a light-incident side or a light-emitting side of the liquid crystal cell.

In the display panel of the present invention, the compensation film is disposed between a polarizing film of the polarizers and the liquid crystal cell.

The display panel of the present invention has the following beneficial effects: a low cost and a wide viewing angle, so as to solve the problems that the contrast of the conventional display panel is reduced, and the dual compensation films have a higher cost.

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a structural diagram showing a display panel according to a first preferred embodiment of the present invention;

FIG. 2 is a structural diagram showing a display panel according to a second preferred embodiment of the present invention;

FIG. 3 is a structural diagram showing a liquid crystal cell and a compensation film according to the first preferred embodiment of the present invention;

FIG. 4 is a diagram showing an equal contrast ratio contour of a conventional display panel without using the compensation film;

FIG. 5 is a diagram showing an equal contrast ratio contour of a conventional display panel using the dual compensation films;

FIG. 6 is a diagram showing an equal contrast ratio contour using the display panel according to the first preferred embodiment of the present invention;

FIG. 7 is a diagram showing an equal contrast ratio contour using the display panel according to the second preferred embodiment of the present invention;

FIG. 8 is a diagram showing an equal contrast ratio contour using the display panel according to a third preferred embodiment of the present invention;

FIG. 9 is a diagram showing an equal color difference contour of a conventional display panel without using the compensation film;

FIG. 10 is a diagram showing an equal color difference contour of a conventional display panel using the dual compensation films;

FIG. 11 is a diagram showing an equal color difference contour using the display panel according to the first preferred embodiment of the present invention;

FIG. 12 is a diagram showing an equal color difference contour using the display panel according to the second preferred embodiment of the present invention;

FIG. 13 is a diagram showing an equal color difference contour using the display panel according to a third preferred embodiment of the present invention;

### DETAILED DESCRIPTION OF THE PREFERRED EMBODIMENTS

The following embodiments are referring to the accompanying drawings for exemplifying specific implementable embodiments of the present invention.

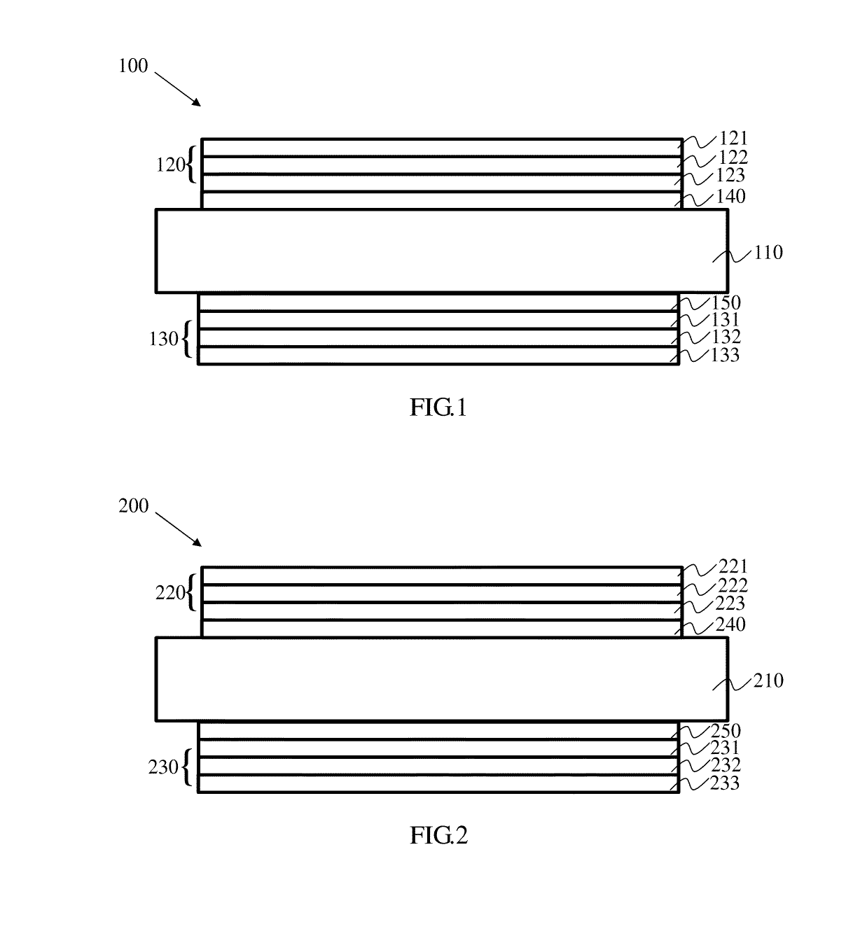

Referring to FIG. 1, a structural diagram showing a display panel according to a first preferred embodiment of the present invention is illustrated. The display panel 100 comprises a liquid crystal cell 110 and two polarizers disposed at both sides of the liquid crystal cell 110, and one of the polarizers at a light-incident side of the liquid crystal cell 110 includes a compensation film 132. As shown in FIG. 1, the display panel 100 comprises the liquid crystal cell 110, the light-emitting polarizer 120 and the light-incident polarizer 130. The liquid crystal cell 110 comprises a first substrate, a second substrate and a liquid crystal layer. In this embodiment, the first substrate may be a glass substrate or other material substrate with color filters (CF), and the second substrate may be a glass substrate or other material substrate with a thin film transistor (TFT) array. It notes that the CF and the TFT array may also be disposed on the same substrate in other embodiments.

The display panel 100 comprises a protective film 121, a polarizing film 122, a protective film 123, an adhesive layer 140, the liquid crystal cell 110, an adhesive layer 150, the compensation film 131, a polarizing film 132 and a protective film 133 in sequence from inside to outside. In this case, the outside structures of the protective film 121, the polarizing film 122 and the protective film 123 form the light-emitting polarizer 120 at a light-emitting side. The inside structures of the compensation film 131, the polarizing film 132 and the protective film 133 form the light-incident polarizer 130 at the light-incident side. The light-emitting polarizer 120 is bonded to a light-emitting surface of the liquid crystal cell 110 by using the adhesive layer 140, and the light-incident polarizer 130 is bonded to a light-incident surface of the liquid crystal cell 110 by using the adhesive layer 150. when using the display panel 100, an incident light enters the light-incident polarizer 130, and the polarizing film 132 of the light-incident polarizer 130 the polarizes the incident light, and then the compensation film 131 of the light-incident polarizer 130 compensates the refractive index of the liquid crystal cell 110 in different directions for modifying the optical path difference at different viewing angles. Thereafter, the compensated light is emitted into the liquid crystal cell 110, and the light is emitted out the light-emitting polarizer 120 at one side of the liquid crystal cell 110 after polaroid analysis.

In the FIG. 1, a first optical path difference R₀ of the compensation film 131 is 0.15 to 0.35 times an optical path difference R of the liquid crystal cell, and the first optical path difference R₀ is expressed as follows:

R₀=|nₓ−n_{y}|×d,

and the optical path difference R of the liquid crystal cell is expressed as follows:

R=Δn×d′,

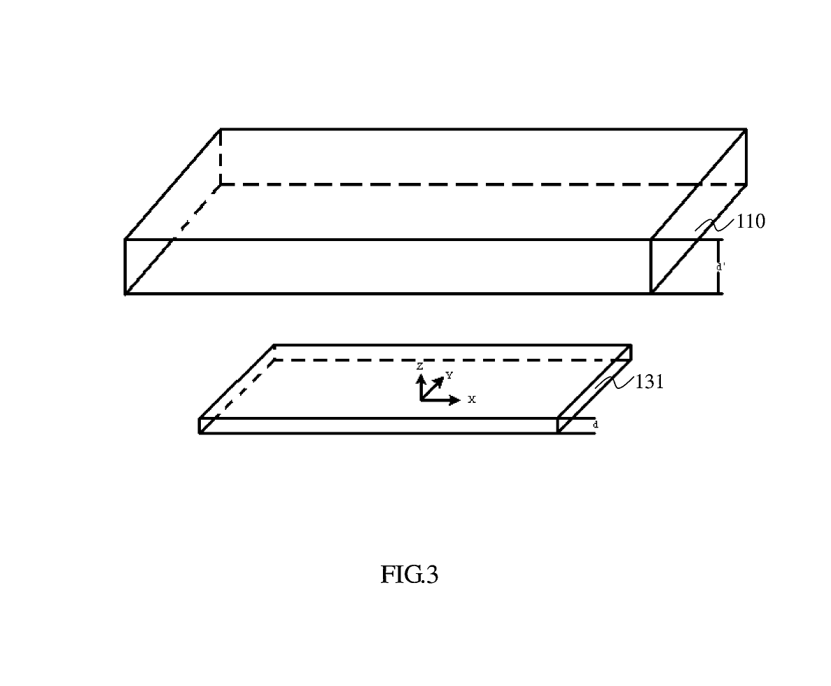

In this case, nₓ indicates the refractive index of the compensation film 131 in a first direction X, and n_{y} indicates the refractive index of the compensation film 131 in a second direction Y, and the first direction X and the second direction Y are vertical to each other and parallel to a light-incident surface of the compensation film 131, and d indicates a thickness of the compensation film 131, and Δn indicates a refractive index difference of liquid crystal molecules of the liquid crystal cell 110, and d′ indicates a thickness of the liquid crystal cell 110 (referring to FIG. 3).

In the FIG. 1, a second optical path difference Rₜₕ of the compensation film 131 is 0.6 to 1.2 times the optical path difference R of the liquid crystal cell, and the second optical path difference Rₜₕ of the compensation film is expressed as follows:

Rₜₕ=|(nₓ+n_{y})/2−n_{z}|*d,

wherein n_{z} indicates the refractive index of the compensation film 131 in a third direction Z, and the third direction Z is vertical to the first direction X and the second direction Y (referring to FIG. 3).

In this case, the thickness d′ of the liquid crystal cell 110 is preferably 3 μm to 4 μm, and the refractive index difference Δn of the liquid crystal molecules of the liquid crystal cell 110 is preferably 0.07 to 0.11, so as to achieve an optimum compensation effect of the compensation film 131.

The compensation film 131 is disposed between the polarizing film 132 of the light-incident polarizer 130 and the liquid crystal cell 110, thereby efficiently compensating the optical path difference in different directions by means of the compensation film 131, as well as protecting the compensation film 131.

Referring to FIG. 2, a structural diagram showing a display panel according to a second preferred embodiment of the present invention is illustrated. The display panel 200 comprises a liquid crystal cell 210 and two polarizers disposed at both sides of the liquid crystal cell 210, and one of the polarizers at a light-emitting side of the liquid crystal cell 110 includes a compensation film 223. As shown in FIG. 2, display panel 200 comprises a protective film 221, a polarizing film 222, the compensation film 223, an adhesive layer 240, the liquid crystal cell 210, an adhesive layer 250, the compensation film 231, a polarizing film 232 and a protective film 233 in sequence from inside to outside. In this case, the outside structures of the protective film 221, the polarizing film 222 and the compensation film 223 form the light-emitting polarizer 220 at the light-emitting side. The inside structures of the protective film 231, the polarizing film 232 and the protective film 233 form the light-incident polarizer 230 at the light-incident side. The light-emitting polarizer 220 is bonded to a light-emitting surface of the liquid crystal cell 210 by using the adhesive layer 240, and the light-incident polarizer 230 is bonded to a light-incident surface of the liquid crystal cell 210 by using the adhesive layer 250. when using the display panel 200, an incident light enters the light-incident polarizer 230, and the polarizing film 232 of the light-incident polarizer 230 the polarizes the incident light, and then the light is emitted into the liquid crystal cell 210. Subsequently, the compensation film 223 of the light-emitting polarizer 220 compensates the refractive index of the liquid crystal cell 210 in different directions for modifying the optical path difference at different viewing angles. Thereafter, the light is emitted out the polarizing film 222 after polaroid analysis.

In the FIG. 2, a first optical path difference R₀ of the compensation film 223 is 0.15 to 0.35 times an optical path difference R of the liquid crystal cell, and the first optical path difference R₀ is expressed as follows:

R₀=|nₓ−n_{y}|×d,

and the optical path difference R of the liquid crystal cell is expressed as follows:

R=Δn×d′,

In this case, nₓ indicates the refractive index of the compensation film 223 in a first direction X, and n_{y} indicates the refractive index of the compensation film 223 in a second direction Y, and the first direction X and the second direction Y are vertical to each other and parallel to a light-incident surface of the compensation film 223, and d indicates a thickness of the compensation film 223, and Δn indicates a refractive index difference of liquid crystal molecules of the liquid crystal cell 210, and d′ indicates a thickness of the liquid crystal cell 210.

In the FIG. 2, a second optical path difference Rₜₕ of the compensation film 223 is 0.6 to 1.2 times the optical path difference R of the liquid crystal cell, and the second optical path difference Rₜₕ of the compensation film is expressed as follows:

Rₜₕ=|(nₓ+n_{y})/2−n_{z}|*d,

wherein n_{z} indicates the refractive index of the compensation film 131 in a third direction Z, and the third direction Z is vertical to the first direction X and the second direction Y.

In this case, the thickness d′ of the liquid crystal cell 110 is preferably 3 μm to 4 μm, and the refractive index difference Δn of the liquid crystal molecules of the liquid crystal cell 210 is preferably 0.07 to 0.11, so as to achieve an optimum compensation effect of the compensation film 223.

The compensation film 223 is disposed between the polarizing film 222 of the light-emitting polarizer 220 and the liquid crystal cell 210, thereby efficiently compensating the optical path difference in different directions by means of the compensation film 223, as well as protecting the compensation film 223.

The following preferred embodiment is referring to equal contrast ratio contours and equal color difference contours of the display of the present invention for exemplifying that the display of the present invention with low cost can provide a wide-viewing-angle display similar to the effect by using the dual compensation films.

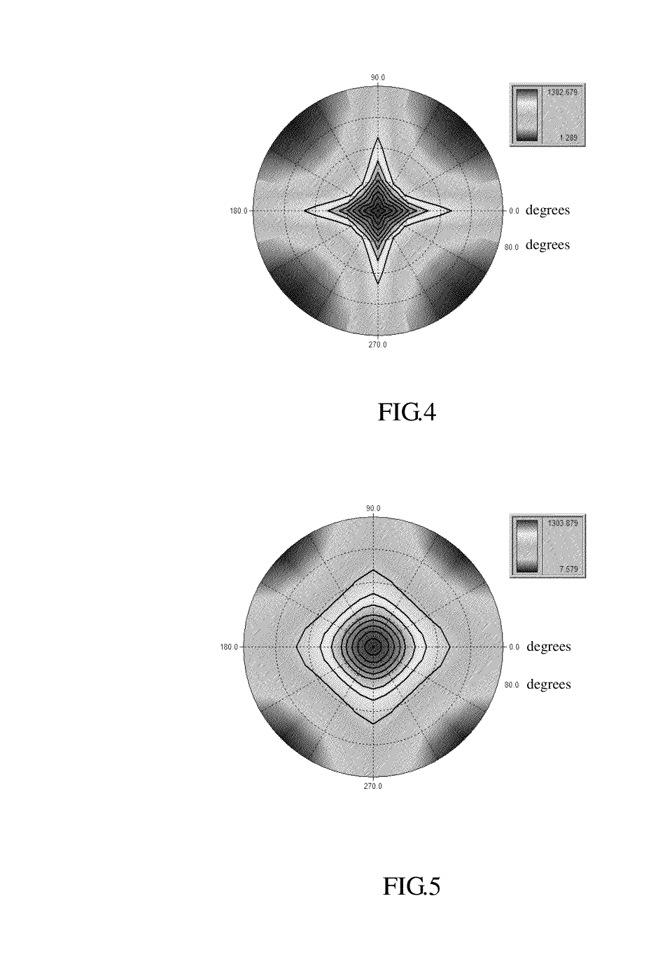

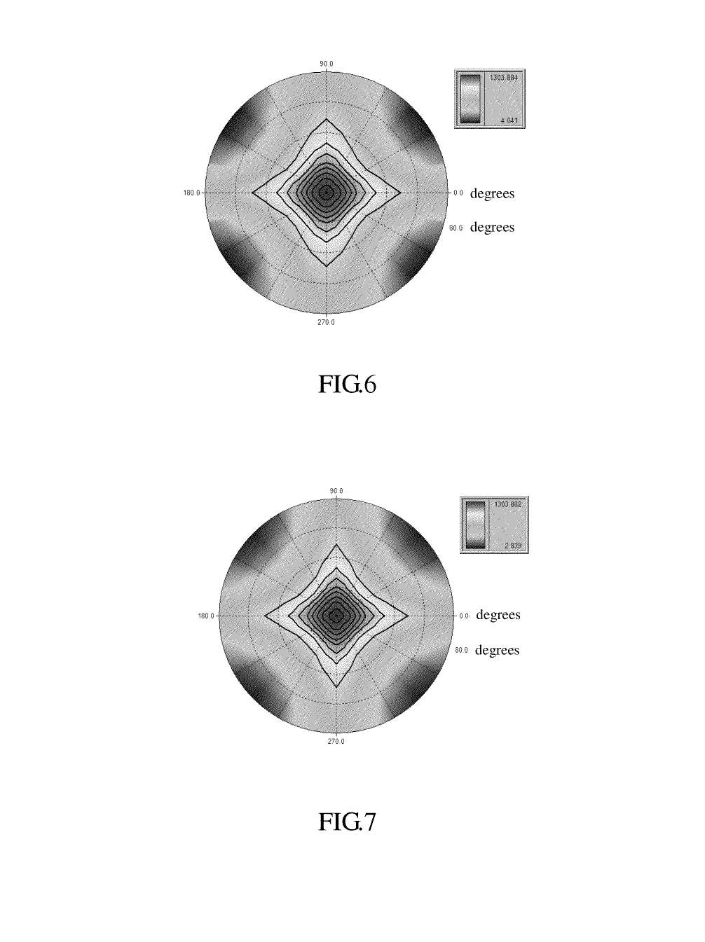

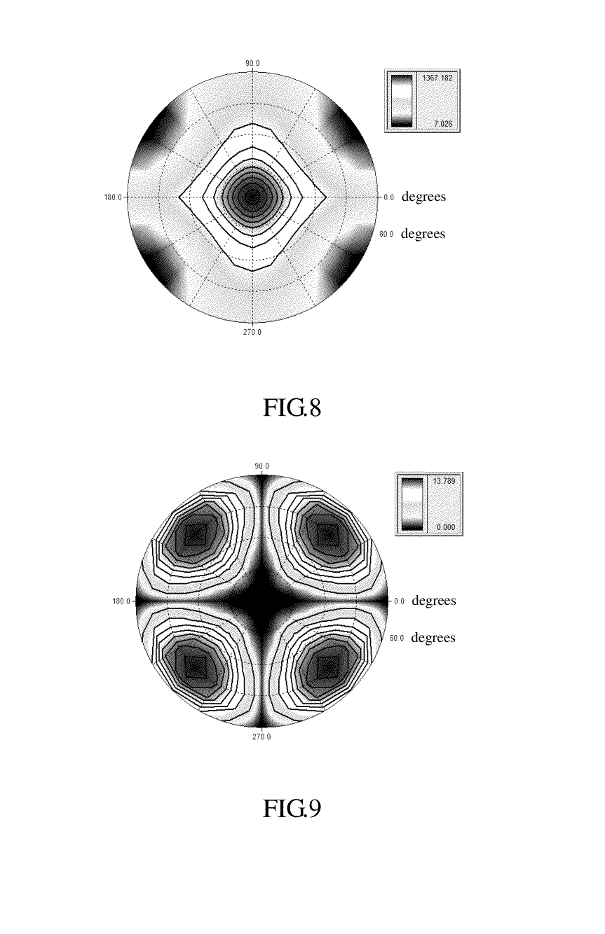

In this case, FIG. 4 shows the equal contrast ratio contour of a display panel without using the compensation film, and FIG. 5 shows the equal contrast ratio contour of a display panel using the dual compensation films, wherein the first optical path difference R₀ of the compensation film is about 0.18R, and the second optical path difference Rₜₕ is about 0.4R. FIG. 6 shows the equal contrast ratio contour of a display panel using the single compensation film with the first optical path difference R₀ of 0.15R to 0.35R and the second optical path difference Rₜₕ of about 0.47R. FIG. 7 shows the equal contrast ratio contour of a display panel using the single compensation film with the first optical path difference R₀ of about 0.125R and the second optical path difference Rₜₕ of 0.6R to 1.2R. FIG. 8 shows the equal contrast ratio contour of a display panel using the single compensation film with the first optical path difference R₀ of 0.15R to 0.35R, and the second optical path difference Rₜₕ of 0.6R to 1.2R.

As shown in FIG. 4, a contrast difference between different viewing angles of the display panel without using the compensation film is larger, and the display panel using the dual compensation films as shown in FIG. 5 can have an improved contrast uniformity at different viewing angles. The contrast uniformity at different viewing angle of the display panel using the single compensation film as shown in FIG. 6 and FIG. 7 is also better than the display panel without using the compensation film. The contrast uniformity at different viewing angle of the display panel using the single compensation film as shown in FIG. 8 is almost similar to the contrast uniformity at different viewing angle of the display panel using the dual compensation films, thereby achieving a compensation effect of using the dual compensation films.

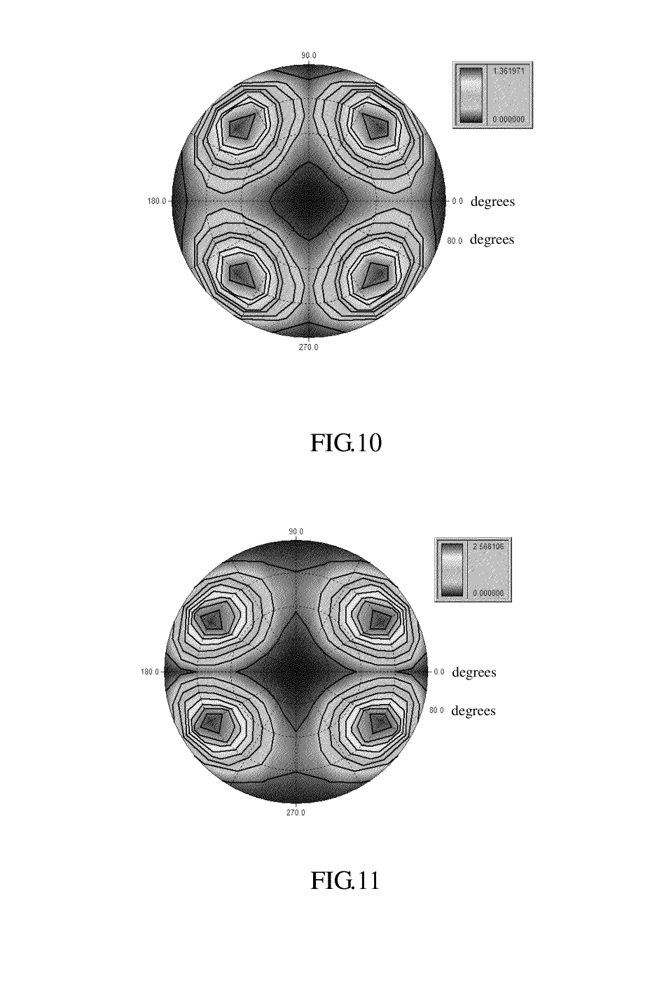

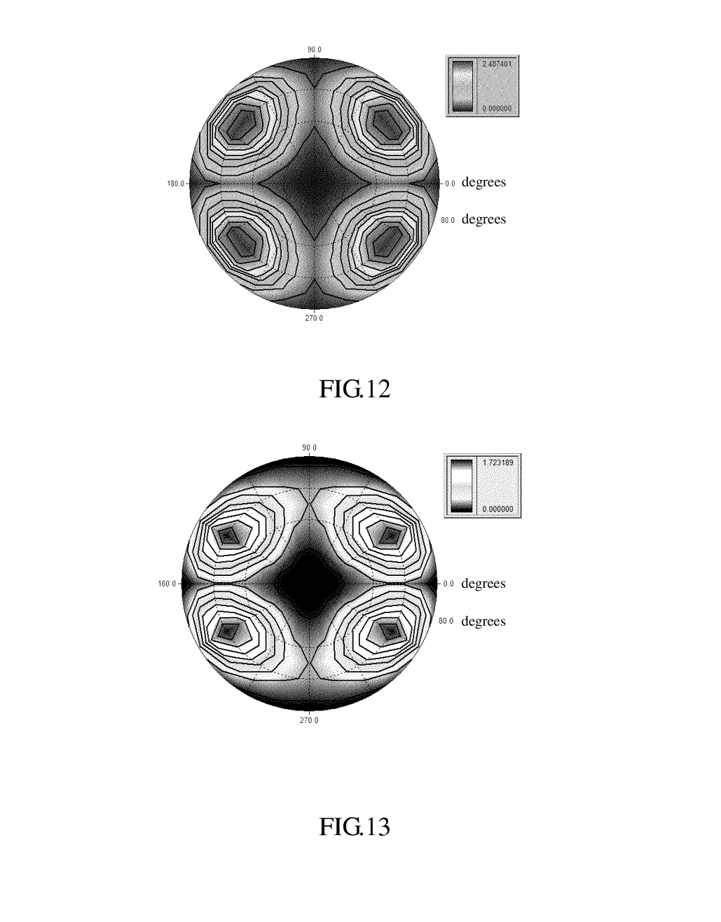

FIG. 9 shows the equal color difference contour (at the viewing angle of 60 degrees) of a display panel without using the compensation film, and FIG. 10 shows the equal color difference contour (at the viewing angle of 60 degrees) of a display panel using the dual compensation films, wherein the first optical path difference R₀ of the compensation film is about 0.18R, and the second optical path difference Rₜₕ is about 0.4R. FIG. 11 shows the equal color difference contour (at the viewing angle of 60 degrees) of a display panel using the single compensation film with the first optical path difference R₀ of 0.15R to 0.35R and the second optical path difference Rₜₕ of about 0.47R. FIG. 12 shows the equal color difference contour (at the viewing angle of 60 degrees) of a display panel using the single compensation film with the first optical path difference R₀ of about 0.125R and the second optical path difference Rₜₕ of 0.6R to 1.2R. FIG. 13 shows the equal color difference contour (at the viewing angle of 60 degrees) of a display panel using the single compensation film with the first optical path difference R₀ of 0.15R to 0.35R, and the second optical path difference Rₜₕ of 0.6R to 1.2R.

As shown in drawings, the display panel as shown in FIG. 13 has the best color difference range which is only better than the display panel using the dual compensation films as shown in FIG. 10. The color difference range of the display panel as shown in FIG. 11 and FIG. 12 is greatly better than the color difference range of the display panel without using the compensation film as shown in FIG. 9. Therefore, the color difference range of the display panel using the single compensation film can similar to the color difference range using the dual compensation films, even better than the color difference range using the dual compensation films, thereby achieving a compensation effect of using the dual compensation films.

The present invention has been described with a preferred embodiment thereof and it is understood that many changes and modifications to the described embodiment can be carried out without departing from the scope and the spirit of the invention that is intended to be limited only by the appended claims.

1. A display panel, characterized in that: comprising:
a liquid crystal cell; and
two polarizers disposed at both sides of the liquid crystal cell, respectively, wherein one of the polarizers at one side of the liquid crystal cell includes a compensation film, and a first optical path difference R₀ of the compensation film is 0.15 to 0.35 times an optical path difference R of the liquid crystal cell, and the first optical path difference R₀ and the optical path difference R of the liquid crystal cell are expressed as follows:
R₀=|nₓ−n_{y}|×d,R=Δn×d′,
wherein nₓ indicates the refractive index of the compensation film in a first direction, and n_{y} indicates the refractive index of the compensation film in a second direction, and the first direction and the second direction are vertical to each other and parallel to a light-incident surface of the compensation film, and d indicates a thickness of the compensation film, and Δn indicates a refractive index difference of liquid crystal molecules of the liquid crystal cell, and d′ indicates a thickness of the liquid crystal cell;
wherein a second optical path difference Rₜₕ of the compensation film is 0.6 to 1.2 times the optical path difference R of the liquid crystal cell, and the second optical path difference Rₜₕ of the compensation film is expressed as follows:
Rₜₕ=|(nₓ+n_{y})/2−n_{z}|*d,
wherein n_{z} indicates the refractive index of the compensation film in a third direction, and the third direction is vertical to the first direction and the second direction, and a value of Δn is 0.07 to 0.11, and a value of d′ is 3 μm to 4 μm, and the compensation film is disposed on one of the polarizers at a light-incident side or a light-emitting side of the liquid crystal cell, and the compensation film is disposed between a polarizing film of the polarizers and the liquid crystal cell.

2. A display panel, characterized in that: comprising:
a liquid crystal cell; and
two polarizers disposed at both sides of the liquid crystal cell, respectively, wherein one of the polarizers at one side of the liquid crystal cell includes a compensation film, and a first optical path difference R₀ of the compensation film is 0.15 to 0.35 times an optical path difference R of the liquid crystal cell, and the first optical path difference R₀ and the optical path difference R of the liquid crystal cell are expressed as follows:
R₀=|nₓ−n_{y}|×d,R=Δn×d′,
wherein nₓ indicates the refractive index of the compensation film in a first direction, and n_{y} indicates the refractive index of the compensation film in a second direction, and the first direction and the second direction are vertical to each other and parallel to a light-incident surface of the compensation film, and d indicates a thickness of the compensation film, and Δn indicates a refractive index difference of liquid crystal molecules of the liquid crystal cell, and d′ indicates a thickness of the liquid crystal cell.

3. The display panel according to claim 2, characterized in that: a second optical path difference Rₜₕ of the compensation film is 0.6 to 1.2 times the optical path difference R of the liquid crystal cell, and the second optical path difference Rₜₕ of the compensation film is expressed as follows:
Rₜₕ=|(nₓ+n_{y})/2−n_{z}|*d,
wherein n_{z} indicates the refractive index of the compensation film in a third direction, and the third direction is vertical to the first direction and the second direction.

4. The display panel according to claim 2, characterized in that: a value of Δn is 0.07 to 0.11.

5. The display panel according to claim 2, characterized in that: a value of d′ is 3 μm to 4 μm.

6. The display panel according to claim 2, characterized in that: the compensation film is disposed on one of the polarizers at a light-incident side or a light-emitting side of the liquid crystal cell.

7. The display panel according to claim 2, characterized in that: the compensation film is disposed between a polarizing film of the polarizers and the liquid crystal cell.

8. The display panel according to claim 3, characterized in that: a value of Δn is 0.07 to 0.11.

9. The display panel according to claim 3, characterized in that: a value of d′ is 3 μm to 4 μm.

10. The display panel according to claim 3, characterized in that: the compensation film is disposed on one of the polarizers at a light-incident side or a light-emitting side of the liquid crystal cell.

11. The display panel according to claim 3, characterized in that: the compensation film is disposed between a polarizing film of the polarizers and the liquid crystal cell.

12. The display panel according to claim 4, characterized in that: a value of d′ is 3 μm to 4 μm.

13. The display panel according to claim 4, characterized in that: the compensation film is disposed on one of the polarizers at a light-incident side or a light-emitting side of the liquid crystal cell.

14. The display panel according to claim 4, characterized in that: the compensation film is disposed between a polarizing film of the polarizers and the liquid crystal cell.

15. The display panel according to claim 5, characterized in that: the compensation film is disposed on one of the polarizers at a light-incident side or a light-emitting side of the liquid crystal cell.

16. The display panel according to claim 5, characterized in that: the compensation film is disposed between a polarizing film of the polarizers and the liquid crystal cell.

17. The display panel according to claim 6, characterized in that: the compensation film is disposed between a polarizing film of the polarizers and the liquid crystal cell.

18. The display panel according to claim 12, characterized in that: the compensation film is disposed on one of the polarizers at a light-incident side or a light-emitting side of the liquid crystal cell.

19. The display panel according to claim 12, characterized in that: the compensation film is disposed between a polarizing film of the polarizers and the liquid crystal cell.

20. The display panel according to claim 18, characterized in that: the compensation film is disposed between a polarizing film of the polarizers and the liquid crystal cell.
